(19) United States
(12) Patent Application Publication
(10) Pub. No.: US 2026/0167468 A1
(43) Pub. Date: Jun. 18, 2026

(54) VEHICLE MOVING SYSTEM

(71) Applicants: Hyundai Motor Company, Seoul (KR); Kia Corporation, Seoul (KR)

(72) Inventors: Dae Young GWON, Hwaseong-si (KR); Ji Hyun Song, Hwaseong-si (KR)

(73) Assignees: Hyundai Motor Company, Seoul (KR); Kia Corporation, Seoul (KR)

(21) Appl. No.: 19/225,912

(22) Filed: Jun. 2, 2025

(30) Foreign Application Priority Data
Dec. 16, 2024 (KR) 10-2024-0187327

(51) Int. Cl. B66F 7/24; B60S 13/00

(52) U.S. Cl. CPC B66F 7/24; B60S 13/00

(57) ABSTRACT

A vehicle moving system includes a guide rail provided on a wall surface; a docking unit slidably engaged to the guide rail and including a wheel coupling unit configured to be coupled with a wheel of a vehicle and receive a driving force from the wheel; and a driving unit disposed between the docking unit and the guide rail. The driving unit is configured to receive the driving force from the wheel coupling unit and enable the docking unit to slide along the guide rail.

### CROSS-REFERENCE TO RELATED APPLICATION(S)

This application is based on and claims priority under 35 U.S.C. 119 to Korean Patent Application No. 10-2024-0187327, filed on Dec. 16, 2024, in the Korean Intellectual Property Office, the disclosure of which is herein incorporated by reference in its entirety.

### BACKGROUND

### Technical Field

The present disclosure relates to a vehicle moving system that enables a vehicle to slide and move along the wall surface of a building by directly using the vehicle's own wheel driving force.

### Description of the Related Art

Recently, various transportation means deviating from the forms of conventional vehicles have been proposed through autonomous driving and electrification of vehicles. For example, as the forms of conventional vehicles diversify, vehicles are being assembled in various ways based on their purpose, or vehicles are being combined with drone devices to enable them to run on the ground or move in the air.

Furthermore, with the increasing variety of vehicle types, concepts of integrating vehicles and buildings have been proposed to allow the interior space of a vehicle to serve as one of the spaces within a building.

Various transportation means, including vehicles, may be defined as transportation mobility. This transportation mobility may be connected to a desired point of a building, allowing direct entry into or exit from the transportation mobility within the building, and may be docked at a desired point in the building to constitute a space in the building.

To achieve this, technology that allows transport mobility to move freely and be mounted or coupled at various points of the building is required.

The foregoing described as the background art is intended merely to aid in the understanding of the background of the present disclosure, and is not intended to mean that the present disclosure falls within the purview of the related art already known to those skilled in the art.

### SUMMARY

This disclosure is proposed to solve such problems and aims to provide a vehicle moving system that enables a vehicle to slide and move along the wall surface of a building by directly using the vehicle's own wheel driving force.

The technical subjects pursued in the present disclosure may not be limited to the above-mentioned technical subjects, and other technical subjects which are not mentioned may be clearly understood from the following descriptions by those skilled in the art to which the present disclosure pertains.

In view of the foregoing, a vehicle moving system according to the present disclosure includes: a guide rail disposed on a wall surface of a building; a docking unit slidably engaged to the guide rail and including a wheel coupling unit configured to be coupled with a wheel of a vehicle and receive a driving force from the wheel; and a driving unit disposed between the docking unit and the guide rail. The driving unit is configured to receive the driving force from the wheel coupling unit and enable the docking unit to slide along the guide rail.

In an exemplary embodiment of the present disclosure, the docking unit may include a frame surrounding the vehicle, and the wheel coupling unit may be provided on the frame.

In an exemplary embodiment of the present disclosure, the frame may include: a base engaged to the guide rail via the driving unit; a pair of extensions bent from opposite end portions of the base and extending to cover the vehicle; and distal end portions bendable from end portions of the extensions to surround the vehicle.

In an exemplary embodiment of the present disclosure, the distal end portions may be configured to: rotatable at the end portions of the extensions; when the distal end portions are in an open state, allow the vehicle to enter the frame; after the vehicle enters the frame, rotate to allow the frame to surround the vehicle.

In an exemplary embodiment of the present disclosure, the wheel coupling unit may be provided in plural on the base and the distal end portions.

In an exemplary embodiment of the present disclosure, the wheel coupling unit may include a rotating unit supporting the wheel of the vehicle, and rotate together with the wheel when the wheel is driven. A rotational force from the rotating unit may be transmitted to the driving unit.

In an exemplary embodiment of the present disclosure, the wheel coupling unit may include a power generation unit generating electricity using rotational force of the rotating unit, and the driving unit may be configured to be driven by receiving the electricity from the power generation unit.

In an exemplary embodiment of the present disclosure, the vehicle moving system may further include a lifting unit disposed on a ground under the docking unit, and the lifting unit may lift the vehicle off the ground when the vehicle enters the docking unit and the wheel coupling unit of the docking unit is coupled with the wheel of the vehicle.

In an exemplary embodiment of the present disclosure, the driving unit may be coupled to surround the guide rail, and the driving unit, and the guide rail may be connected by a ball nut mechanism to allow the driving unit to slide along the guide rail.

In an exemplary embodiment of the present disclosure, the driving unit may include a rack gear disposed on the guide rail and a pinion gear engaged with the rack gear, the wheel coupling unit may be configured to rotate together with the wheel of the vehicle, and the pinion gear may slide along the rack gear when the wheel of the vehicle is driven.

In an exemplary embodiment of the present disclosure, the driving unit may include a pulley connected to the wheel coupling unit and a wire wound around the pulley, the wheel coupling unit may be coupled with the wheel of the vehicle to rotate therewith, and when the wheel of the vehicle is driven, the pulley may slide while rotating to wind or unwind the wire.

In an exemplary embodiment of the present disclosure, the guide rail may extend in an up-down direction along the wall surface of the building.

In an exemplary embodiment of the present disclosure, the docking unit may slide on the guide rail in the up-down direction along the wall surface of the building in a state of being connected to the vehicle.

According to a vehicle moving system of the present disclosure, a vehicle moves along the wall surface of a building by directly using the driving force of the vehicle's wheels, eliminating the need for separate power for lifting the vehicle. As a result, the system is lightweight and easy to maintain.

In addition, the reduced cost of installing the system enables vehicle lifting systems to become more widely adopted.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The above and other aspects, features and advantages of the present disclosure will be more apparent from the following detailed description taken in conjunction with the accompanying drawings, in which:

FIG. 1, FIG. 2, FIG. 3 and FIG. 4 are views illustrating the operation of a vehicle moving system according to an exemplary embodiment of the present disclosure;

FIG. 5 and FIG. 6 are views illustrating a wheel coupling unit of the vehicle moving system according to an exemplary embodiment of the present disclosure;

FIG. 7 and FIG. 8 are views illustrating a docking unit of the vehicle moving system according to an exemplary embodiment of the present disclosure;

FIG. 9 is a view illustrating a driving unit of the vehicle moving system according to an exemplary embodiment of the present disclosure; and

FIG. 10 and FIG. 11 are views illustrating a driving unit of the vehicle moving system according to an exemplary embodiment of the present disclosure.

### DETAILED DESCRIPTION

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure. The following descriptions are not intended to limit the present disclosure to the described form or specific field, and it is considered that various alternative modifications and changes may be made to the present disclosure regardless of whether the descriptions are explicit or implicit. Those skilled in the art to which the present disclosure pertains will appreciate that the contents of the present disclosure may be changed in forms and details.

The present disclosure will be described with reference to specific embodiments. However, as understood by a person ordinarily skilled in the art, the various aspects disclosed herein may be modified or otherwise implemented in different ways without departing from the spirit and scope of the present disclosure. Accordingly, the following description is to be considered exemplary, and is intended to teach those ordinarily skilled in the art how to make and use various embodiments. It is to be understood that the forms of the disclosure illustrated and described herein are exemplary embodiments. Equivalent elements, materials, processes, or steps may be substituted for those exemplified and described in the present disclosure. Expressions used in this disclosure, such as “including”, “comprising”, “incorporating”, “consisting of”, “having”, or “is”, should be interpreted in a non-exclusive manner, i.e., to allow for the inclusion of items, components, or elements not explicitly listed. In addition, references to the singular form should be interpreted to include the plural form as well.

Furthermore, the various embodiments included herein should be regarded as exemplary and descriptive, and should not be construed as limiting the scope of the present disclosure. All references to joining (e.g., attached, affixed, coupled, and connected) are used solely to facilitate understanding of the present disclosure and are not intended to limit the position, orientation, or use of any component or method included herein. Accordingly, references to joining should be interpreted broadly. Moreover, these references to joining do not imply that two or more elements are directly connected to each other. Furthermore, all numerical terms, such as “first”, “second”, “third”, “primary”, “secondary”, “main”, or any other generic terms or numerical expressions, are to be understood solely as identifiers to aid in the understanding of the various components, embodiments, modifications, or variations of the present disclosure, and do not imply any limitations as to any component, embodiment, modification, variation, or their order or preference. That is, these terms may be used to describe various components but should not be construed as limiting the components to those terms. These terms are used only to distinguish one component from another.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

Furthermore, a unit or a control unit included in names is merely a term widely used for naming a controller configured to control a specific function of a vehicle, but does not mean a generic function unit.

To control functions in charge, a controller may include a communication device configured to communicate with a sensor or another controller, a memory configured to store an operating system or logic instructions and input/output information, and at least one processor configured to perform determination, calculation, decision or the like required for control of the functions in charge.

Any number or variety of components in any of the configurations described herein may be included within the scope of the present disclosure described herein. The components may include any combination of the features described herein and may be arranged in any of the various configurations described herein. The concepts related to the structure and arrangement of the components of the present disclosure, as well as their use and operation, may be applied to any number of embodiments in any combination, as well as to the specific embodiments discussed herein. Embodiments including those having various features in various arrangements are described below with reference to the drawings.

Hereinafter, embodiments set forth herein will be described in detail with reference to the accompanying drawings, and the same or similar elements are given the same and similar reference numerals regardless of figure numbers, so duplicate descriptions thereof will be omitted.

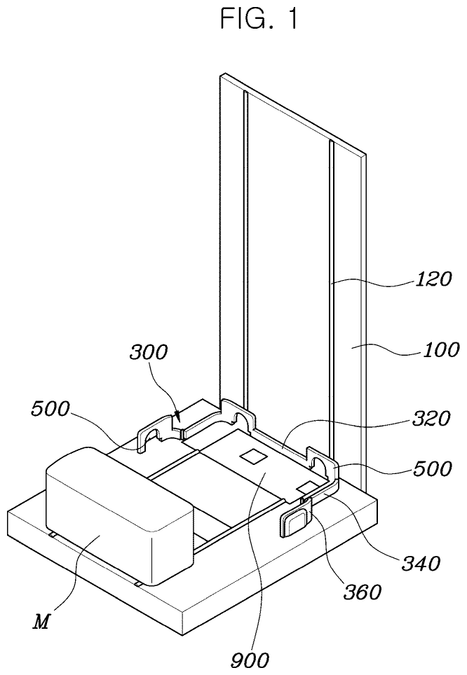

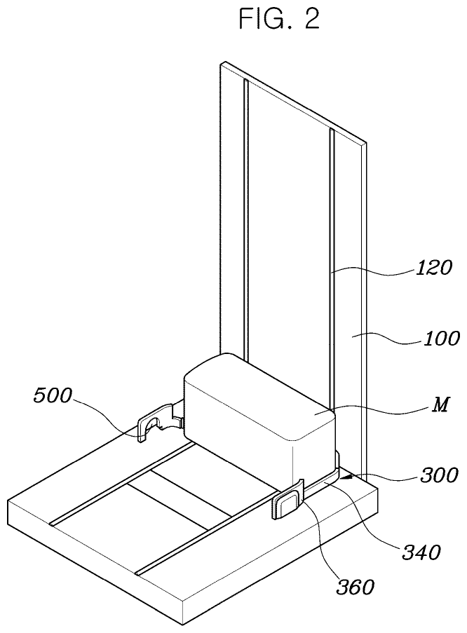

FIGS. 1 to 4 are views exemplarily illustrating the operation of a vehicle moving system according to an exemplary embodiment of the present disclosure. The vehicle moving system of the present disclosure is configured to move a vehicle along the wall surface of a building or the like. While a building is provided as a representative example of the target for vehicle movement, the system may also be applied to cases where a vehicle moves along the wall surface of a general structure other than buildings.

Furthermore, while the direction of vehicle movement in the illustrated embodiment is exemplified as lifting in the up-down direction, the configuration of the present disclosure may, of course, be applied to movement not only in an up-down direction but also in lateral, diagonal, or horizontal directions.

Accordingly, the present disclosure is not limited in its scope to buildings, nor is the direction of vehicle movement restricted to a specific direction.

Hereinafter, the vehicle moving system of the present disclosure will be described with reference to the drawings, and as a representative embodiment, an example of lifting a vehicle in the up-down direction along the wall surface of a building will be described.

As illustrated in FIG. 1, a guide rail 120 is provided in the up-down direction or vertically on the wall surface 100 of a building. The guide rail 120 is provided in the up-down direction to guide the movement of the vehicle M in the up-down direction along the wall surface 100 of the building.

The guide rail 120 may include a groove shape recessed on the wall surface 100, may be a vertically extending rack gear, an electromagnet, or a metal rail. That is, the guide rail 120 may be implemented in various forms as long as it enables the vehicle M to move in the up-down direction thereof.

A driving unit 700 is provided on the guide rail 120. As described above, the driving unit 700 is connected to the guide rail 120 through various methods, such as a gear mechanism, an electromagnetic mechanism, or a linear motor mechanism, and the driving unit 700 is configured for moving in the up-down direction along the guide rail 120 while being driven. The power for the driving unit 700 is received from a wheel M10 of the vehicle M.

The docking unit 300 is connected to the driving unit 700, and the vehicle M is connected to the docking unit 300. Accordingly, when the driving unit 700 operates, the docking unit 300 is lifted in the up-down direction along the guide rail 120 together with the driving unit 700, and the vehicle M, which is constrained to the docking unit 300, is also lifted in the up-down direction along with the docking unit.

The docking unit 300 should allow the vehicle M to be mounted thereon while receiving the driving force from the wheel M10 of the vehicle. As a structure for the present purpose, an exemplary embodiment of the present disclosure proposes a docking unit 300 in a form of a frame that surrounds the exterior of the vehicle, as illustrated.

In an exemplary embodiment of the present disclosure, the docking unit 300 includes a frame that surrounds the vehicle, and a wheel coupling unit 500 may be provided on the frame. In an exemplary embodiment of the present disclosure, the frame may include a base 320 connected to the guide rail 120 via the driving unit 700, a pair of extensions 340 bent from opposite end portions of the base 320 and extending to cover the vehicle M, and distal end portions 360 bent from the end portions of the extensions 340 to surround the vehicle M.

In an exemplary embodiment of the present disclosure, the distal end portions 360 may be rotatably connected to the end portions of the extension portions 340. In a state where the distal end portions 360 are open, the vehicle M may enter the frame, and after the vehicle M enters, the distal end portions 360 can rotate to surround the vehicle with the frame.

In an exemplary embodiment of the present disclosure, a plurality of wheel coupling units 500 may be provided on the base 320 and the distal end portions 360.

The docking unit 300 is manufactured in the shape of a frame that surrounds the vehicle. While various materials may be used for the docking unit 300, it is advantageous to mold the docking unit from steel material to support the weight of the vehicle.

The docking unit 300 is configured in a form of a frame divided into a plurality of articulated segments, enabling it to accommodate vehicles of various sizes

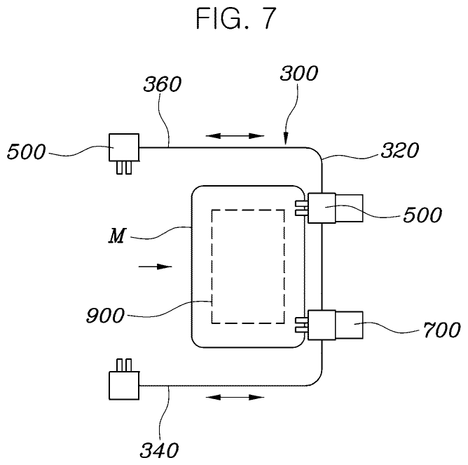

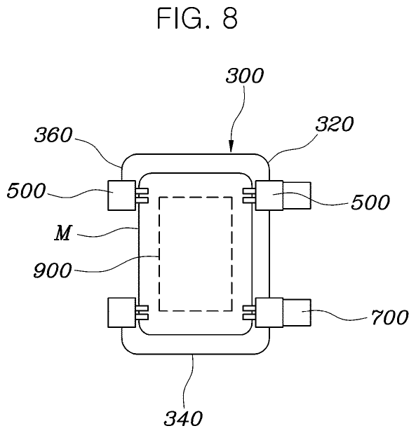

FIGS. 7 and 8 are views exemplarily illustrating the operation of the docking unit of the vehicle moving system according to an exemplary embodiment of the present disclosure. The docking unit 300 includes a base 320 connected to the wall surface 100 of a building via driving units 700 and positioned adjacent to the wall surface 100. The base 320 extends in the longitudinal direction along the wall surface 100 in a form of a bar, with a length slightly longer than the overall length of a vehicle. When the base 320 is configured to allow extension at opposite end portions, it may be configured to vehicles of various lengths.

At the opposite end portions of the base 320, a pair of extensions 340 are formed and bent to extend and cover the front and rear sides of the vehicle M, respectively. The extensions 340 are bent about 90 degrees at the end portions of the base 320 to serve to enclose the front and rear sides of the vehicle M. Furthermore, wheel coupling units 500 are provided on the base 320 to be engaged with the wheels M10 of the vehicle M positioned adjacent to the wall surface 100 of the building. The base 320 is provided with two wheel coupling units 500 spaced apart in the front-rear direction, so that the wheel coupling units 500 may be respectively engaged with the two wheels M10 provided on one side of the vehicle M.

At the end portions of the pair of extensions 340 provided in the front-rear direction, distal end portions 360 are connected, respectively. As illustrated, the distal end portions 360 are configured to rotate at the end portions of the extensions 340. The distal end portions 360 are provided with wheel coupling units 500, respectively, which are engaged with the wheels M10 on the side of the vehicle opposite to the wall surface 100.

Accordingly, when a vehicle enters the interior of the docking unit 300 to be engaged with the locking unit 300, the distal end portions 360 rotate to open, as illustrated in FIG. 7, and the vehicle M enters the open space. If the extensions 340 or the distal end portions 360 are configured to be extendable, various types of vehicles M may be docked regardless of the widths thereof. The extensions 340 and the distal end portions 360 may be configured as telescopic frames, allowing their lengths to be actively controlled by the controller using separate motors or the like.

That is, during the vehicle's entry, when a separate input is received or data related to the overall length and width of the vehicle is obtained by capturing the vehicle with a camera or the like, the lengths of the base 320, the extensions 340, and the distal end portions 360 are actively adjusted, enabling docking with various sizes and types of vehicles.

Once the entry of the vehicle M to the docking unit 300 is completed, the distal end portions 360 rotate, as illustrated in FIG. 8, to cover the opposite side surface of the vehicle M. Accordingly, the wheel coupling units 500 provided on the distal end portions 360 are engaged with the wheels M10 of the vehicle. Preferably, docking according to the rotation of the distal end portions 360 is performed after identifying, through an image sensor, a distance sensor, or the like provided in the docking unit 300, that the vehicle has fully entered and the wheels M10 are engaged with the wheel coupling units 500.

Accordingly, the vehicle M is completely surrounded by the docking unit 300, and the wheels M10 of the vehicle are engaged with the plurality of wheel coupling units 500 provided in the docking unit 300. When the docking unit 300 is lifted, the vehicle M is lifted therewith.

FIGS. 1 to 4 are views exemplarily illustrating the operation of the vehicle moving system according to an exemplary embodiment of the present disclosure. As illustrated in FIG. 1, in a state where the distal end portions 360 of the docking unit 300 are open, the vehicle M enters the interior of the docking unit 300 toward the wall surface 100. The vehicle's wheels M10 applied in the instant case are assumed to be wheels configured for rotating 90 to 360 degrees. As illustrated in FIG. 2, when the vehicle M has fully entered, the wheel coupling units 500 located on the wall surface 100 are first engaged with the nearby wheels M10 of the vehicle. For the present engagement, the vehicle M may be maintained in a slightly lifted state from the ground using a lifting unit 900 while in the entered state.

After the engagement between the vehicle M and the wall surface-side wheel coupling units 500 is completed, as illustrated in FIG. 3, the distal end portions 360 of the docking unit 300 rotate to be engaged with the opposite side surface of the vehicle M. The wheel coupling units 500 provided on the distal end portions 360 are engaged with the opposite-side wheels M10 of the vehicle M. Accordingly, the engagement between the vehicle M and the docking unit 300 is completed. In the instant state, as illustrated in FIG. 4, when the driving unit 700 is operated, the vehicle M ascends along the guide rail 120 on the wall surface 100 of the building together with the docking unit 300, and the lifting unit 900 on the ground is lowered back to its original position.

Here, in the case of the present disclosure, as illustrated in FIG. 4, the power for lifting the docking unit 300 through the driving unit 700 is obtained from the driving force of the vehicle's wheels M10. That is, as illustrated in FIG. 4, while the vehicle M is ascending, the wheels M10 of the vehicle continuously operate, and the driving force of the wheels M10 enables the docking unit 300 to ascend. Accordingly, since no separate power is required for the ascent or descent of the docking unit 300, the system is simplified. As a result, the weight that needs to be lifted is reduced, allowing energy to be used efficiently. Furthermore, the cost of constructing the system is reduced, creating a favorable environment for widespread application of the vehicle moving system of the present disclosure.

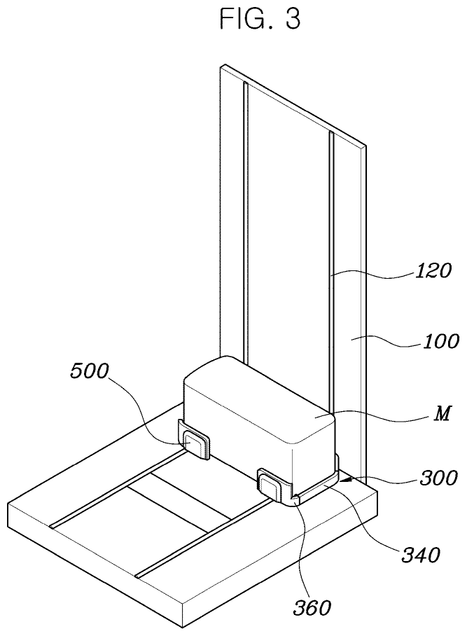

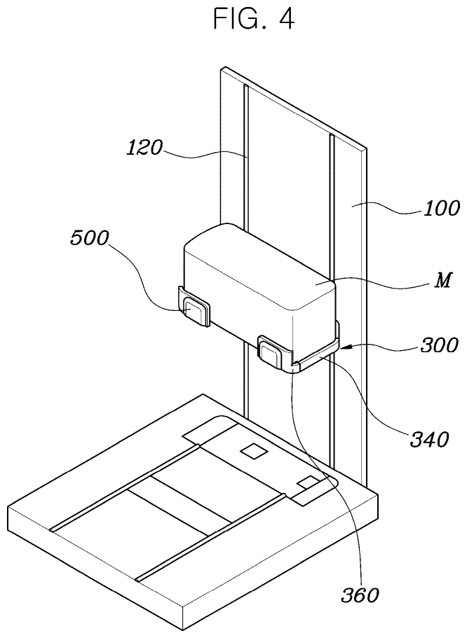

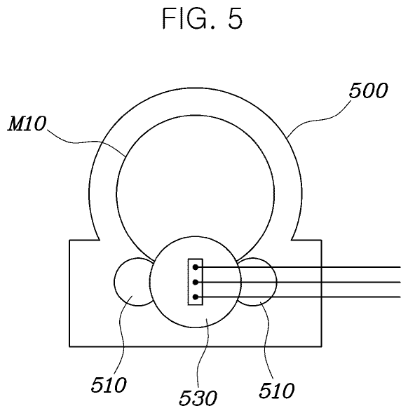

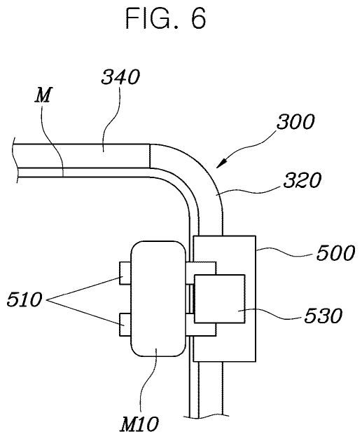

FIGS. 5 and 6 are views exemplarily illustrating a wheel coupling unit 500 of the vehicle moving system according to an exemplary embodiment of the present disclosure. According to the illustrated embodiment, the wheel coupling unit 500 includes a rotating unit 510 configured to support a wheel M10 of a vehicle and rotate together with the vehicle's wheel M10 during its operation. The rotational force of the rotating unit 510 may be transmitted to the driving unit 700. An example of the rotating unit 510 includes a pair of rollers that support the vehicle wheel M10. The rollers support a single wheel M10 of the vehicle from the front and rear and rotate together with the wheel M10 due to the friction between the rollers and the vehicle wheel M10 when the wheel is driven. The rollers are connected to a generator 530 and generate electricity through the generator 530.

The rotational force of the rotating unit 510 provided in the wheel coupling unit 500 is obtained from the vehicle's wheel M10. The rotating unit 510 generates power using its rotational force, and the generated electricity is used to cause the docking unit 300 to ascend via the driving unit 700.

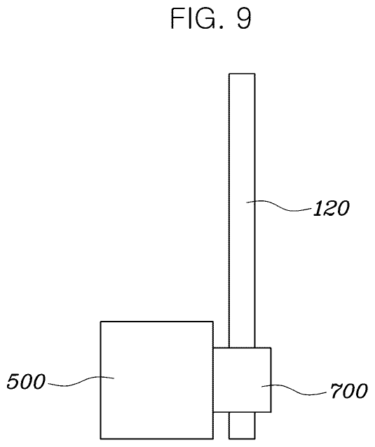

FIG. 9 is a view exemplarily illustrating the driving unit 700 of the vehicle moving system according to an exemplary embodiment of the present disclosure. In an exemplary embodiment of the present disclosure, the driving unit 700 is coupled to surround the guide rail 120, and the driving unit 700 and the guide rail 120 are connected using a ball-nut mechanism, allowing the driving unit 700 to slide along the guide rail 120. That is, the guide rail 120 takes the form of a bolt with threads formed on its external circumferential surface, and a nut surrounding it rotates using the power from the power generating unit, enabling the driving unit 700 to ascend or descend along the guide rail 120. In other words, the driving unit 700 may be configured to surround the guide rail 120 and have threads formed on an internal surface thereof to be engaged with the threads of the guide rail 120.

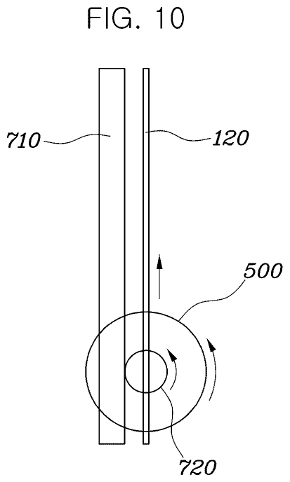

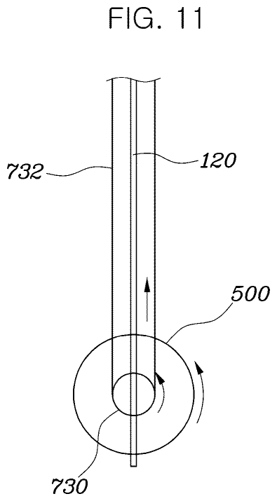

Meanwhile, FIGS. 10 and 11 are views exemplarily illustrating the driving unit of the vehicle moving system according to an exemplary embodiment of the present disclosure.

FIG. 10 illustrates a case where the docking unit 300 ascends and descends using a rack-and-pinion mechanism. Specifically, in an exemplary embodiment of the present disclosure, the driving unit 700 includes a rack gear 710 provided on the guide rail 120 and a pinion gear 720 connected to the wheel coupling unit 500 to be engaged with the rack gear 710. The wheel coupling unit 500 is engaged with a vehicle's wheel M10 and rotates together with the wheel. When the vehicle's wheel M10 is driven, the pinion gear 720 is slidable along the rack gear 710. The guide rail 120 is provided vertically along the wall surface 100.

The rack gear 710 is spaced laterally apart from the guide rail 120 and extends vertically. The rack gear 710 has gear teeth continuously formed on one side thereof. The wheel coupling unit 500 is connected to the vehicle's wheel M10 and rotates together with it. The wheel coupling unit 500 is provided with the pinion gear 720 to rotate therewith. The pinion gear 720 is engaged with the rack gear 710 and moves up and down along the rack gear 710 while rotating. Furthermore, the pinion gear 720 and the wheel coupling unit 500 are connected to the guide rail 120 to ensure stable guidance for ascent and descent. Accordingly, when the vehicle's wheel M10 rotates, the rotation of the pinion gear 720 causes the docking unit 300 and the vehicle M to ascend and descend as a whole along the guide rail 120 and the rack gear 710.

FIG. 11 illustrates vertical movement using a pulley 730 and a wire 732. In an exemplary embodiment of the present disclosure, the driving unit 700 includes a pulley 730 connected to the wheel coupling unit 500 and a wire 732 wound around the pulley 730. The wheel coupling unit 500 is engaged with the vehicle's wheel M10 and rotates therewith. When the vehicle's wheel M10 is driven, the pulley 730 rotates to wind or unwind the wire 732, allowing the vehicle M to slide.

That is, when the driving force of the vehicle's wheel M10 rotates the pulley 730, the pulley 730 winds or unwinds the wire 732. The wire 732 is fixed at its lower end portion to the pulley 730 and at its upper end portion to the upper portion of the building. When the pulley 730 rotates to wind the wire 732 therearound, the pulley 730 ascends, and accordingly, the wheel coupling unit 700, the vehicle M, and the docking unit 300 ascend together. Conversely, when the pulley 730 rotates in the direction to unwind the wire 732, the vehicle M descends along the wall surface 100.

For such ascent and descent of the vehicle, the wheels M10 of the vehicle M should be driven in the forward or reverse direction thereof. The present operation may be performed either by the driver operating the vehicle M onboard or through remote control. Furthermore, the wheel coupling units 500 and the vehicle's wheels M10 may be connected to each other through a mechanical mechanism or an electromagnetic mechanism using an electromagnet.

According to a vehicle moving system of the present disclosure described above, a vehicle moves along the wall surface of a building by directly using the driving force of the vehicle's wheels, eliminating the need for separate power for lifting the vehicle. As a result, the system is lightweight and easy to maintain.

Furthermore, the reduced cost of installing the system enables vehicle lifting systems to become more widely adopted.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A vehicle moving system comprising:
a guide rail disposed on a wall surface of a building;
a docking unit slidably engaged to the guide rail and comprising a wheel coupling unit configured to be coupled with a wheel of a vehicle and receive a driving force from the wheel; and
a driving unit disposed between the docking unit and the guide rail and engaged to the wheel coupling unit, the driving unit being configured to receive the driving force from the wheel coupling unit and move the docking unit to slide along the guide rail.

2. The vehicle moving system of claim 1, wherein the docking unit comprises a frame surrounding the vehicle, and the wheel coupling unit is provided on the frame.

3. The vehicle moving system of claim 2, wherein the frame comprises:
a base engaged to the guide rail via the driving unit;
a pair of extensions bent from opposite end portions of the base and extending to cover the vehicle; and
distal end portions bendable from end portions of the extensions to surround the vehicle.

4. The vehicle moving system of claim 3, wherein the extensions are configured as telescopic frames to be selectively extendable.

5. The vehicle moving system of claim 4, further includes a controller to control a length of the telescopic frames.

6. The vehicle moving system of claim 3, wherein the distal end portions are configured as telescopic frames to be selectively extendable.

7. The vehicle moving system of claim 6, further includes a controller to control a length of the telescopic frames.

8. The vehicle moving system of claim 3, wherein the distal end portions are configured to:
be rotatable at the end portions of the extensions;
in a state where the distal end portions are in an open state, allow the vehicle to enter the frame; and
after the vehicle enters the frame, rotate to allow the frame to surround the vehicle.

9. The vehicle moving system of claim 8,
wherein the wheel coupling unit is provided in plural, and
wherein first and second wheel coupling units among the plurality of wheel coupling units are mounted to each of the distal end portions, respectively.

10. The vehicle moving system of claim 8, wherein a predetermined number of wheel coupling units among the wheel coupling units is disposed on the base.

11. The vehicle moving system of claim 3, wherein the wheel coupling unit is disposed in plural on the base and the distal end portions.

12. The vehicle moving system of claim 1, wherein the wheel coupling unit comprises a rotating unit supporting the wheel of the vehicle, and rotate together with the wheel based on that the wheel is driven, and a rotational force from the rotating unit is transmitted to the driving unit.

13. The vehicle moving system of claim 12, wherein the wheel coupling unit comprises a power generation unit generating electricity using the rotational force of the rotating unit, and the driving unit is driven by the electricity received from the power generation unit.

14. The vehicle moving system of claim 1, further comprising:
a lifting unit disposed on a ground under the docking unit,
wherein based on that the vehicle enters the docking unit, the lifting unit lifts the vehicle off the ground and the wheel coupling unit of the docking unit is coupled with the wheel of the vehicle.

15. The vehicle moving system of claim 1, wherein the driving unit is coupled to surround the guide rail, and the driving unit and the guide rail are connected by a ball nut mechanism to allow the driving unit to slide along the guide rail.

16. The vehicle moving system of claim 1, wherein the driving unit comprises a rack gear disposed on the guide rail and a pinion gear engaged with the rack gear and connected to the wheel coupling unit, the wheel coupling unit rotates together with the wheel of the vehicle, and the pinion gear slides along the rack gear based on that the wheel of the vehicle is driven.

17. The vehicle moving system of claim 1, wherein the driving unit comprises a pulley connected to the wheel coupling unit and a wire wound around the pulley, the wheel coupling unit is coupled with the wheel of the vehicle to rotate therewith, and based on that the wheel of the vehicle is driven, the pulley slides while rotating to wind or unwind the wire.

18. The vehicle moving system of claim 1, wherein the guide rail is disposed to extend in an up-down direction along the wall surface of the building.

19. The vehicle moving system of claim 1, wherein the docking unit slides on the guide rail in an up-down direction along the wall surface of the building in a state of being connected to the vehicle.
